(19) United States
(12) Patent Application Publication
(10) Pub. No.: US 2008/0189139 A1
(43) Pub. Date: Aug. 7, 2008

(54) INTERACTIVE UNIFIED WORKSTATION FOR BENCHMARKING AND CARE PLANNING

(75) Inventors: Rohit Sachdeva, Plano, TX (US); Sanjeev Taneja, Plano, TX (US); Charles L. Abraham, Dallas, TX (US); Peer Sporbert, Berlin (DE); Phillip Getto, Plano, TX (US); Jay R. Widdig, Allen, TX (US)

Correspondence Address: ORAMETRIX, INC., 2350 CAMPBELL CREEK BOULEVARD, SUITE 400, RICHARDSON, TX, 75082, US

(73) Assignee: OraMetrix, Inc.

(21) Appl. No.: 12/052,420

(22) Filed: Mar. 20, 2008

Related U.S. Application Data
(62) Division of application No. 10/429,074, filed on May 2, 2003.

(51) Int. Cl. G06Q 50/00

(52) U.S. Cl. 705/3; 705/2

(57) ABSTRACT

An interactive, unified workstation is described that unifies in a single system multitude of functions pertaining to a practitioners practice that would otherwise require disjointed, more expensive, and less efficient individual workstations dedicated to a specific, limited task or a sub-set of tasks. The invention is directed towards benchmarking for a practitioner's business practice, and for clinical aspects of treatment planning; and integrating overall patient care planning functions. The unified workstation further facilitates access to archived database resources and facilitates both knowledge base services to practitioners and also hybrid treatment planning, wherein different types of appliance systems (fixed, such as brackets and wires, or removable, such as aligning shells) may be used during the course of treatment.

### RELATED APPLICATION

This application is divisional application of prior application Ser. No. 10/429,074, filed May 2, 2003, pending, which is related to patent application filed on May 2, 2003, entitled “UNIFIED WORKSTATION FOR VIRTUAL CRANIOFACIAL DIAGNOSIS, TREATMENT PLANNING AND THERAPEUTICS”, Rohit Sachdeva et al, inventors, Ser. No. 10/429,123, pending, the entire contents of which are incorporated by reference herein; and to a patent application filed on May 2, 2003, inventors Rohit Sachdeva et al., entitled METHOD AND SYSTEM FOR INTEGRATED ORTHODONTIC TREATMENT PLANNING USING UNIFIED WORKSTATION, Ser. No. 10/428,461, pending, the entire contents of which are incorporated by reference herein.

### BACKGROUND OF THE INVENTION

A. Field of the Invention

This invention relates to the field of computerized techniques for enhancing the scope and performance of medical, dental, and orthodontic practices from the business aspects as well as the care planning and delivery aspects concerning human patients. More particularly, the invention is directed to an interactive workstation and associated computerized techniques for facilitating practice benchmarking, clinical benchmarking, care planning, and providing other services for the benefit of the practitioner and the patient.

B. Description of Related Art

In recent years, computer-based approaches have been proposed for aiding orthodontists in their practice. However, these approaches are limited to diagnosis and treatment planning of craniofacial structures, including the straightening of teeth. See Andreiko, U.S. Pat. No. 6,015,289; Snow, U.S. Pat. No. 6,068,482; Kopelmann et al., U.S. Pat. No. 6,099,314; Doyle, et al., U.S. Pat. No. 5,879,158; Wu et al., U.S. Pat. No. 5,338,198, and Chisti et al., U.S. Pat. Nos. 5,975,893 and 6,227,850, the contents of each of which is incorporated by reference herein. Also see imaging and diagnostic software and other related products marketed by Dolphin Imaging, 6641 Independence Avenue, Canoga Park, Calif. 91303-2944. A method for generation of a 3D model of the dentition from an in-vivo scan of the patient, and interactive computer-based treatment planning for orthodontic patients, is described in published PCT patent application of OraMetrix, Inc., the assignee of this invention, publication no. WO 01/80761, the contents of which are incorporated by reference herein. Other background references related to capturing three dimensional models of dentition and associated craniofacial structures include S. M. Yamany and A. A. Farag, “A System for Human Jaw Modeling Using Intra-Oral Images” in Proc. IEEE Eng. Med. Biol. Soc. (EMBS) Conf., Vol. 20, Hong Kong, October 1998, pp. 563-566; and M. Yamany, A. A. Farag, David Tasman, A. G. Farman, “A 3-D Reconstruction System for the Human Jaw Using a Sequence of Optical Images,” IEEE Transactions on Medical Imaging, Vol. 19, No. 5, May 2000, pp. 538-547. The contents of these references are incorporated by reference herein.

The technical literature further includes a body of literature describing the creation of 3D models of faces from photographs, and computerized facial animation and morphable modeling of faces. See, e.g., Pighin et al., Synthesizing Realistic Facial Expression from Photographs, Computer Graphics Proceedings SIGGRAPH '98, pp. 78-94 (1998); Pighin et al., Realistic Facial Animation Using Image-based 3D Morphing, Technical Report no. UW-CSE-97-01-03, University of Washington (May 9, 1997); and Blantz et al., A Morphable Model for The Synthesis of 3D Faces, Computer Graphics Proceedings SIGGRAPH '99 (August, 1999). The contents of these references are incorporated by reference herein.

Computerized tools for orthodontic modeling and treatment planning are marketed by companies such as Align Technology, Inc., 881 Main Avenue, Santa Clara, Calif. 95050; Ormco Corporation, 1717 West Collins, Orange, Calif. 92867; and Cadent Inc., 640 Gotham Parkway, Carlstadt, N.J. 07072-2405. However, they are all specialized for their respective products; and thus limited in functionalities.

The art has lacked a truly interactive, integrated and unified system which facilitates practice and clinical benchmarking, and unifying other functionalities of a practice such as for planning of care for medical and dental human patients.

A principal benefit of the invention is that it provides a workstation that integrates practice benchmarking, clinical benchmarking, treatment planning, and other functions for delivering care to a patient in the same system; thus eliminating the need for more expensive and less efficient multiple workstations wherein each workstation is dedicated to performing one specific function or a limited sub-set of functions necessary in a practitioner's practice.

### SUMMARY OF THE INVENTION

In a first embodiment of the invention, the unified workstation facilitates benchmarking practitioner's practice from a business perspective. The workstation maintains a central repository of a practice benchmarking database comprising contemporary performance data from industry standard practices, including, for example, data from superior performing practices, data from educational institutions, data from care institutions, etc. The evaluation of the practice is performed by comparing certain performance metrics for the practice of interest against those of the comparable industry standards; analyzing the differences; reporting the results, and, when the differences indicate inferior performance by the practice of interest in one or more areas, identifying appropriate corrective actions.

In another embodiment of the invention, the unified workstation facilitates selection of an initial treatment plan with the help of a clinical benchmarking database. The method relies upon the use of the clinical benchmarking database, which is created by storing the clinical treatment history of individual patients coupled with a variety of other types of information, such as demographic information concerning patients, practitioners, practice-staff, diagnosis and therapeutics information, the results of patient survey regarding satisfaction with treatment, pain experienced during treatment, reference literature, workflow processes, instrumentation information, etc. Patient diagnosis and characteristics are compared with those in the clinical benchmarking database, and a selection is made of one or more suitable reference treatments. The results are then presented to the practitioner. The practitioner discusses the treatment options with the patient, and, in concurrence with the patient, selects the one that most satisfies the patient needs and constraints, such as the importance the patient places on esthetics in relation to the associated treatment expenditure, patient's insurance coverage, and other similar factors.

In yet another embodiment of the invention, the unified workstation facilitates periodic, ongoing evaluation of a patient's actual, monitored progress in response to the prescribed treatment with the help of the clinical benchmarking database comprising clinical treatment histories and characteristics of a large number of patients. From the database, a reference patient and associated treatment plan that come closest to the patient of interest are chosen. Then, the patient's progress at the particular point in time in the treatment course, e.g. individual tooth movement, is compared against the progress for the reference patient at a comparable elapsed time in the reference patient's treatment, and the results given to the practitioner. In the instances where the actual response matches the expected response, the knowledge so gained could be added to the clinical benchmarking database. Furthermore, if the patient's progress is found to be lagging significantly behind that of the selected reference patient, a root cause analysis is performed to identify the source of the problem. The source of the problem could be either the prescribed treatment or the patient behavior. If the treatment is found lacking, appropriate corrective actions are suggested to the practitioner. On the other hand, if it is determined that the patient might not be adhering to the prescribed treatment regimen, then patient counseling is recommended to the practitioner.

This is a closed-loop approach wherein the actual response to the treatment is utilized in deciding the future course of action. In particular embodiments, the invention can be used to predict the treatment response, such as the tooth-movement behavior. This predicted tooth movement behavior can be used for calendar management for facilitating scheduling of patient's future visits to the practitioner's clinic, and sending out reminders. Moreover, the clinical benchmarking knowledge database supports the use of intelligent queries of the database to seek information regarding practice-related issues, using known database query languages. In the current practice, orthodontists largely rely upon trial and error methods and intuition, and function in a reactive rather than a proactive manner, to make corrective adjustments, which approach may not be the most efficient for delivering care to the patients. A major benefit of the innovative approach proposed herein is that it facilitates consistent and far more effective, evidence based care that closely matches the patient needs, than the traditional hit-and-miss anecdotal care that heavily relies upon experience for success. In turn, this approach leads to much faster, and cost-effective acquisition of the target disposition of the patient, when compared to the traditional approach. Yet another benefit is that the unified workstation facilitates increased productivity from the practitioner and the practitioner's staff, enabling reduction of cost in the delivery of the patient care. Another aspect of this invention is that it enables the practitioner to develop benchmarks personalized to individual patients.

In yet another embodiment of the invention, the unified workstation is used to offer orthodontic clinical benchmarking as a service for initial treatment planning as well as for planning adjustments during the course of the treatment. In varying aspects such a service can be used by the entire care delivery and care consuming enterprise including practitioners, manufacturers and suppliers of appliances, patients, etc.

In yet another embodiment of the invention, the unified workstation offers application specific databases (clinical knowledge database), application specific computerized modeling and simulation tools, and interfaces for accessing other resources in order to facilitate and enable a variety of functionalities and services. These functions and services could include, for example, intelligent queries of the database, seeking information from reference treatments, accessing reference information, meta-analysis of patient studies, etc. These functions would also preferably include software developing a comprehensive treatment plan that is tailored to satisfy patient-specific needs, such as diagnosis, therapeutics planning, and care monitoring and management. Additionally, the software provides the ability to identifying a reference patient in the clinical benchmarking knowledge database that matches, at least approximately, the orthodontic condition of the patient. The software further provides a function of obtaining and using data comprising the condition of the patient during the course of treatment (such as scan data from a scan of the patient's dentition during the course of treatment) and thereby monitoring the progress of the patient in response to the treatment and comparing the monitored progress to an expected progress for the patient. Once the treatment is in progress, the workstation thus provides the capability of periodically monitoring the actual patient response to the treatment, comparing it against the predicted performance, and evaluating the differences between the actual response and the expected response, and in the event that the actual response is unsatisfactory. In preferred embodiments, the software may assist the practitioner or user of the workstation in the performing of a root cause analysis to identify the source of the problem and taking appropriate corrective actions such as adjusting the treatment or counseling the patient.

Other functions or features may be provided in the software, such as:

Automatically generating a template by which a practitioner would enter information in order to query the clinical benchmarking knowledge database, as part of generation of an initial treatment plan;

during the course of the functionalities described above, consulting with other specialists as necessary;

during the course of the functionalities described above, consulting with other tertiary care facilities as necessary;

during the course of the functionalities described above, consulting with resources of manufacturers and suppliers of applicable products as necessary;

during the course of the functionalities described above, consulting with resources of applicable laboratories as necessary;

during the course of the functionalities described above, consulting with archived library resources or research centers as necessary;

conducting the process of functionalities described above, coupled with one or more of the other functionalities mentioned in a closed-loop manner such that the patient care is delivered in the best possible manner in accordance with the patient needs; and creating and updating a comprehensive repository of patient-treatment history knowledge base that might be useful in developing industry standards, the clinical benchmarking knowledge base, and new, more effective products;

bidding by manufacturers, suppliers, and labs for the practitioner's business;

demand aggregation and discount purchasing by individual practitioners or groups of practitioners;

demand aggregation and discount purchasing of care by groups of patients;

medical, dental, and orthodontic referral services;

knowledge base service or a smart service wherein a practitioner selects one or more variables the practitioner would like to track. When the selected variables in actuality approach or cross the desired thresholds, the system would facilitate issuance of warnings, and would identify appropriate corrective actions or options, and/or provide links to other information or knowledge bases which may further suggest corrective actions and options.

computerized, interactive education and training services;

Board Certification facilitation service wherein the regulatory Board is provided with an access, as the practitioner's request, to the practitioner's case records for aiding in the practitioner's professional certification process;

insurance information services;

financial services; etc.

In yet another embodiment of the invention, the unified workstation facilitates a variety of scenarios for assisting in the treatment planning, both during the initial treatment selection phase, and, if necessary, during the midcourse adjustment phase as follows:

(a) The modeling and simulation steps during the treatment planning phase are all completely performed at the unified workstation by utilizing the software resident within the unified workstation system. Such software could be obtained from one or more entities such as appliance manufacturers.

(b) Alternately, the unified workstation simply obtains the results from treatment modeling and simulation done at various entities sites. This could be done by accessing the sites via the Internet links.

(c) A combination of the scenarios (a) and (b) above where complete treatment modeling and simulation related to some of the entities is done at the unified workstation with the resident software, and combined with the treatment modeling and simulation results obtained from the remaining entities.

(d) In conjunction with the scenario (a), (b) or (c), the evaluation and selection or recommendation for selection of the treatment course is done at the unified workstation utilizing software tools that optimize treatment plans in accordance with the patient needs.

(e) The treatment plan in (d) above might be such that only one type of appliances, e.g. fixed of removable, is used during the entire course of the treatment. Alternatively, the treatment plan could be one in which an all-dental approach is taken, restorative devices are used, or prosthetic devices are used.

(f) On the other hand, the treatment plan in (d) above might be such that it is a hybrid plan requiring the use of different types of appliances during the course of the treatment. In the hybrid orthodontic treatment plan, a variety of scenarios is possible. In one type of hybrid treatment plan, different types of appliances might be used at different times during the course of the treatment, e.g., brackets and wires used initially and transparent removable aligning shells used later on. In another type of hybrid treatment plan, different types of appliances might be used simultaneously, for example in different portions of the mouth, for example brackets and wires could be used for certain teeth and transparent removable aligning shells uses for a different set of teeth. A hybrid treatment plan may be chosen right from the beginning, or it may be introduced dynamically at any stage during the treatment course.

Thus, in the broader aspects, we have invented an interactive, unified workstation that not only unifies in a single system multitude of functionalities pertaining to a practitioner's practice that would otherwise require disjointed, more expensive, and less efficient individual workstations dedicated to a specific, limited task or a sub-set of tasks, but also provides additional novel and comprehensive functionalities that would revolutionize the medical, dental, and orthodontic practices and vastly improve the delivery of care to patients in a manner that truly satisfies their needs. The invention is directed towards benchmarking for a practitioner's business practice, as well as for clinical aspects of initial and ongoing treatment planning, towards enabling a variety of novel functionalities and services and integrating overall patient care planning functions, including planning for hybrid treatment.

### BRIEF DESCRIPTION OF THE DRAWINGS

Presently preferred embodiments of the invention are described below in reference to the appended drawings, wherein like reference numerals refer to like elements in the various views, and in which:

FIG. 1 is a block diagram of an orthodontic care environment featuring a plurality of clinics and appliance manufacturers that communicate over the Internet with a service provider that includes an integrated workstation environment in accordance with one possible embodiment of the invention.

FIG. 2 is a diagram of databases that may be maintained in the integrated workstation environment of FIG. 1.

FIG. 3 is a block diagram of an alternative embodiment of the workstation environment of FIGS. 1 and 2 showing other software elements and databases that may be maintained at the service provider.

FIG. 4 is a flow chart depicting an orthodontic practice business evaluation methodology using a benchmarking database that can be implemented in the embodiments of FIGS. 1 and 2.

FIG. 5 is a schematic diagram of the practice benchmarking database of FIG. 2;

FIG. 6 is a flow chart showing a method for planning care of a patient using a clinical benchmarking knowledge base of FIGS. 2 and 3.

FIG. 7 is a schematic diagram of the clinical benchmarking knowledge database.

FIG. 8 is a schematic diagram of a patient database of FIG. 3.

FIG. 9 is a flow chart showing a method of facilitating patient care using a clinical benchmark knowledge database and a patient's response to an initial treatment plan.

FIG. 10 is a flow chart showing an alternative method of facilitating patient care using a clinical benchmark knowledge database and a patient's response to an initial treatment plan.

FIG. 11 is flow chart for facilitating care in an alternative embodiment of the invention.

### DETAILED DESCRIPTION OF PREFERRED EMBODIMENTS

Overview

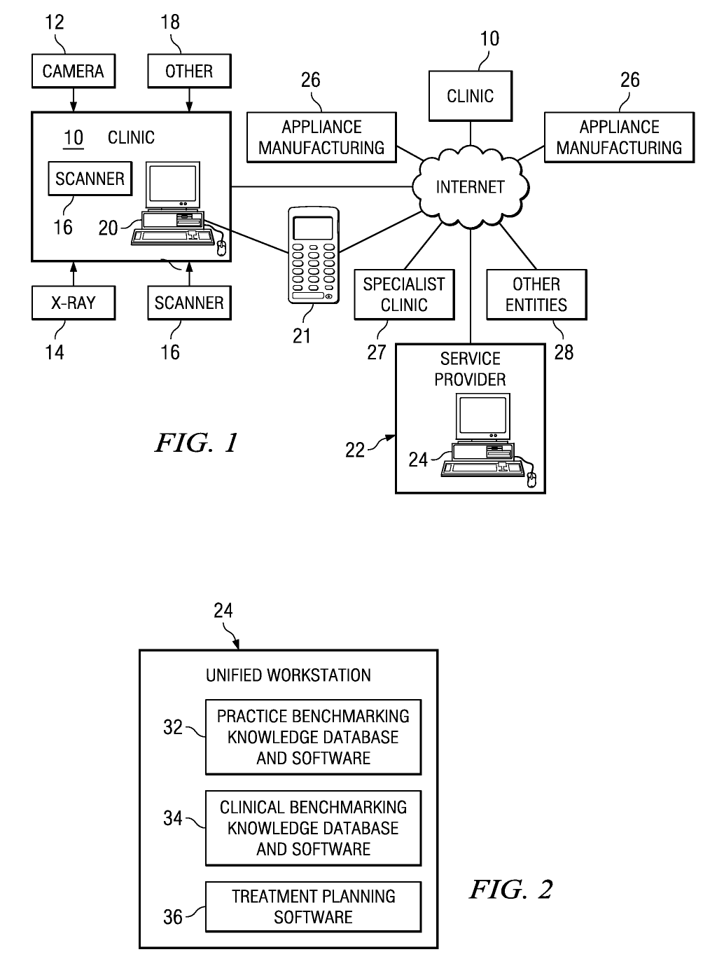

FIG. 1 is a block diagram of an orthodontic care environment in which the present invention can be practiced. The care environment features a plurality of sites 10 which may be the site of an individual orthodontic practitioner or clinic. The sites 10 typically will include one or more imaging devices that obtain patient information in the form of two and three-dimensional images of the patient's craniofacial anatomy including orthodontic structure, i.e., teeth, bones, gingival tissue, and adjacent tissue. These imaging devices may include, for example, a color digital CCD camera 12, an X-Ray machine 14, a scanner 16 for obtaining 3D models of the patient's teeth and associated anatomical structures, and other imaging devices 18, which may or may not be located at the site of the clinic. Patient medical and dental history, insurance information, and other information pertinent to the diagnosis of the patient is obtained. All of this patient information is entered into or otherwise acquired by a general-purpose computer 20, located at the site 10. The computer 20 can be accessed by a device 21 which may be a computer or a terminal located at the practitioner's residence, or a hand held computer such as a pocket computer, personal digital assistant, or any device with similar functionalities.

The computer 20 at the clinics 10, and device 21 are connected to the Internet in known fashion so as to be able to communicate and share files with computers at other remote locations.

The environment shown in FIG. 1 includes a service provider 22 that includes an integrated, unified workstation 24 that is the focus of this invention. The workstation 24 is shown in the form of a general purpose computer 24 that is equipped with a central processing unit, a user interface, and computer software instructions stored in the memory that provide the specific modules and routines shown in the accompanying flow charts. The computer 24 also stores databases of information that are used in providing the services described herein. These databases are described in further detail below. Basically, the computer 24 receives patient or practice information from the sites 10, and uses that information in conjunction with the databases and the other software instructions to provide the evaluation and other services described herein. The details as to the construction and organization of the computer 24 are not particularly important. The computer will typically have static and dynamic memory devices, either local, on attached peripheral devices, or on a network server connected to the computer 24, that contain the database and software features described herein.

Furthermore, while the computer 24 is shown at a service provider site, it is possible to export the software and databases described herein to a computer situated virtually anywhere, such as in one of the clinics or at the appliance manufacturer, and these features could be executed at such locations. Hence, while the description set forth herein will describe the invention in the context of the particular environment of FIG. 1, it will be appreciated that the invention is not so limited. The unified workstation, in general, enables various types of benchmarking evaluations, provides functionalities and facilities for enabling numerous services, and facilitates comprehensive orthodontic care delivery and management. The service provider provides services, with the aid of the unified work station 24, which can vary depending on the specific embodiment of the invention that is put into practice, including but not limited to multidisciplinary consultation, interdisciplinary consultation, practitioner referral service, etc.

These services can include providing practice evaluation from a business point of view, clinical evaluation of patients and recommendations for patient treatment, treatment plan adjustment, and root cause analysis where the course of treatment departs from the expected course of treatment. The service provider 22, in some embodiments of the invention, may also provide treatment planning and appliance design services for practitioners at remotely located clinics.

The environment of FIG. 1 further includes orthodontic appliance manufacturers 26 having servers that are connected to the Internet and allow visitors, such as the workstation 24, to their web sites to access information about their products, services and prices.

Similarly, clinics 27 of specialists, such as endodontists, periodontists, maxillofacial surgeons, prosthodontists, restorative dentists, etc., are also connected via the unified workstation and the Internet to the clinics.

Other entities 28, such as electronic archived library resources, tertiary care facilities, research centers etc. are also connected to the Internet and available as resources to the clinics through the unified workstation 24. Other entities 28 might very include a regulatory Board that periodically certifies the practitioners under its jurisdiction. The service provider 22, in an embodiment of the invention, at a practitioner's request can provide access to appropriate regulatory Board for obtaining information necessary for re-certification of the practitioner. In yet another embodiment of the invention, the service provider 22 can facilitate knowledge-base based smart service. Upon invoking the smart service, a practitioner selects one or more variables the practitioner would like to track, for example the practitioner's monthly income, or the average time between clinic visits of a patient, etc. When the selected variables in actuality approach or cross the desired thresholds (which may be based on then prevailing industry standards), the service would facilitate issuance of warnings, would enable root cause analysis, and would identify appropriate corrective actions or options, and/or provide links to other information or knowledge bases which may further aid in identifying suitable corrective actions. Another feature of this invention is demand aggregation by one or more practitioners or groups of patients for more cost effective purchasing of treatment appliances, supplies, and services. The service provider facilitates archival services as well as knowledge based smart services. A practitioner can use such services to aid in the life-long learning process.

The service provider 22 can offer yet additional services through the unified workstation 24. Such services can include computerized, interactive education and training services, insurance information services, financial services, etc.

The details as to the construction and organization of the workstation are not particularly important. The computer will typically take the form of an Apple or IBM compatible computer and a Windows-based operating system using by a Pentium or similar processor and will have static and dynamic memory devices, either local, on attached peripheral devices, or on a network server connected to the workstation, that contain the database and software features described herein.

In another embodiment, other entities 28 include patient groups that are connected to the unified workstation 24 through the Internet. Through this interface patients can gain access to practitioner referral services. Additionally the patient groups can aggregate their needs and utilize the unified workstation 24 to make bulk purchasing at discounted prices and gain access to variety of bidding services involving manufacturers and practitioners.

FIG. 2 is a diagram of databases that may be maintained in the integrated workstation 24 of FIG. 1. As noted above, the choice of functions, features, and services provided by the computer can vary considerably. In the embodiment of FIG. 2, the integrated workstation or computer 24 is at the facilities of a service provider and includes a memory storing a practice benchmarking knowledge database 32 and associated software. The computer 24 also stores a clinical benchmarking knowledge database 34 and associated software. Furthermore, the computer also includes a treatment planning software 36. The databases and software 32, 34 and 36 basically receive patient or practice information from the clinics and provide evaluation and treatment planning services for practitioners.

In the embodiment of FIG. 2, the service provider provides evaluation services via the knowledge database 32. The service basically compares the performance of the practitioner's practice against accepted industry standards, generally derived from superior performing practices, and provides recommendations in the event that the practice does not meet one or more criteria. The service provider also provides clinical evaluation services via the clinical knowledge database 34 as described herein. The service provider also provides treatment planning services via the treatment planning software 36. This software takes as input 3D and other images and other data of the patient's malocclusion, diagnosis and desired treatment system (e.g., brackets and wires or aligning shells) and prepares a proposed treatment plan for treating the patient and proposes a target or finish tooth position situation to the practitioner.

Representative forms of the databases 32 and 34 are described in more detail herein. The treatment planning software may take the form described in published PCT application of OraMetrix, no. WO 01/80761, the patents of Chisti et al., or Doyle et al., cited previously. The nature of the treatment planning software is not considered important. The descriptions of the treatment planning software of each of the referenced patents and published applications is incorporated by reference herein.

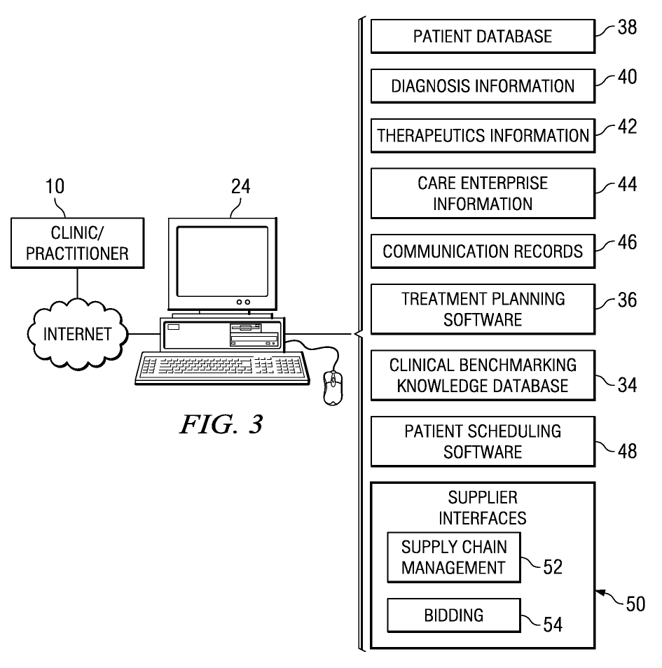

FIG. 3 is a block diagram of an alternative embodiment of the workstation environment of FIGS. 1 and 2 showing other software elements and databases that may be maintained at the service provider. In the embodiment of FIG. 3, the workstation 24 includes a memory (not shown) that stores a patient database 38 (described in further detail below), diagnosis information 40, therapeutics information 42, care enterprise information 44, communication records 46, patient scheduling software 48, care plans, and supplier interfaces that enable the user to communicate with the suppliers or manufacturers of orthodontic appliances. These interfaces 50 may include supply chain management software 52 that manages the flow of goods from the manufacturer and bidding software 54 which enables diverse manufacturers to bid on supplying orthodontic appliances to the practitioner.

The diagnosis information 40 typically includes audio, video, images, text, and data records comprising clinical examination records comprising 2D images, 3D images, CAT scan, MRI, physical model, photographs, digital data from direct scanning of a patient or from scanning of a model representing the patient, ultra-sonic images, X-rays, etc; medical health history; dental health history; and radio graphic examination records. The therapeutic information 42 includes treatment planning and delivery information comprising care plans, delivery means, and delivery schedule for the treatment. The care enterprise information 44 includes care monitoring and management information comprising information on laboratories, manufacturers, and suppliers for testing and delivery of treatment means; information on the practitioner and the practitioner's assistants, and the information on patients and guardians of patients. The information further includes the product information and the supplies information. The laboratories are for example AOA, Great Lakes, etc. Communication records 46 comprise communication between the practitioner and the patient, between the practitioner and another practitioner, between the practitioner and the lab, between the practitioner and the manufacturer, between the practitioner and the supplier, etc. The communication referred to here is a two-way communication between the user of the information and the provider of the information. Elements 38-54 combine to create an extensive knowledge base for the practitioner. This knowledge base is used by the practitioner to mine data and information to facilitate delivery of much improved and more efficient care to patients.

Although not shown in FIG. 3, in another embodiment of the invention the bidding concept may be extended to the practitioners as well as to the patients. Another aspect of the invention is that it can facilitate demand aggregation by the practitioners and/or patients for bulk purchases at reduced costs. As was the case with FIG. 2, the particular location at which the integrated workstation 24 of FIG. 3 is embodied is not particularly important. It could be located at a location such as a service provider place of business, at the location of an appliance manufacturer, in a clinic, or in an individual site of the practitioner.

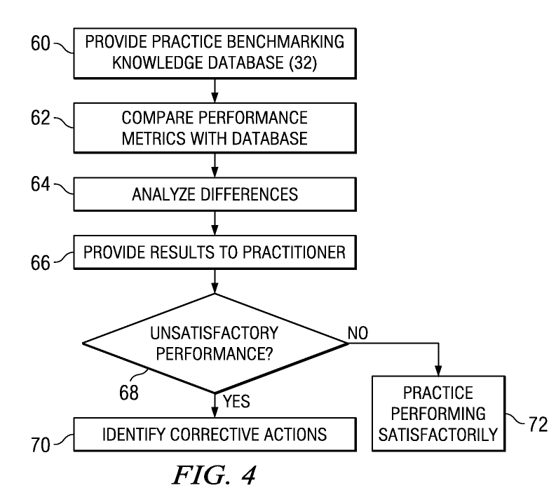

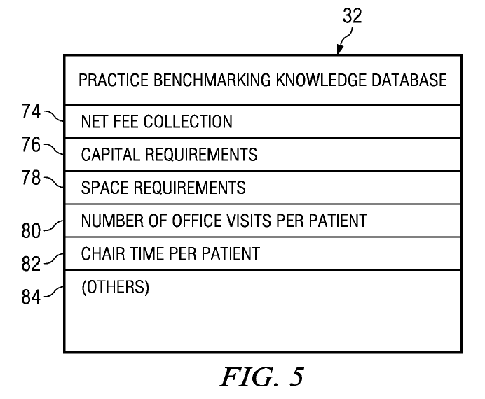

With the above overview in mind and with reference to FIGS. 1-3 and 4, a method for facilitating evaluation of a practitioner's practice from business viewpoint against industry standards will now be described in conjunction with the flow chart of FIG. 4. The method in a preferred embodiment is coded as software instructions in the unified workstation general purpose computer 24 of FIG. 1. The method includes a step 60 of providing a practice benchmarking knowledge database 32 comprising contemporary performance data of industry standard practices. One possible embodiment of the database 32 is shown in FIG. 5 is described hereafter. The method further includes a step 62 of accessing the practice benchmarking knowledge base 32 via computer software instructions so as to compare performance metrics of a practitioner's practice against the industry standard practices.

Step 62 may be accomplished for example by the practitioner sending a file from the clinic to the service provider containing various performance metrics of the practitioners' practice and evaluating those metrics by comparison to the industry standards in the database 32.

The method further includes the step 64 of analyzing, via the computer software instructions, the difference, if any, between each of the performance metrics for the practitioner's practice and the industry standard practices. For example, the software may determine that in three of eleven different categories the practitioners' practice is at or below industry standards. It should be noted that the processing could be done locally locally at the workstation, ort his analysis could be done on a remote computer by a service provider providing performance benchmarking as a service for the practitioner (e.g., for a fee).

The method further includes a step 66 of providing the results of the step of analyzing to the practitioner, for example in the form of a report including graphs, tables etc.

After the results are reported to the practitioner, the method includes a step 68 of determining whether the performance is unsatisfactory. A human may perform the method step 68, for example by a subjective analysis of the report. On the other hand, the step 68 could be performed automatically. For example, if the practice in any one category is below industry standard the results may be deemed “unsatisfactory.”

When the results are unacceptable to the practitioner, the method continues by identifying one or more corrective actions to more closely align the practitioner's practice with the industry standard practices. This step 70 may be performed with the aid of computer software instructions. For example, the computer software may determine at step 66 that the practitioner is averaging an unduly high number of visits per patient during the course of treatment and the instructions may determine that the number of patient visits could be reduced by changing treatment modalities for treating patients. Alternatively, the software could determine that the per-patient net fee income is ten percent below the industry average and propose corrective action of reducing costs in one or more areas, such as by using a different choice of appliance design, supplier, or other solution.

If the step 68 indicates that the practitioner's practice is performing satisfactorily, then at step 72 a positive result is indicated and no need for corrective action is necessarily required.

The method shown in FIG. 4 contemplates a service provider obtaining and maintaining a database of industry standards or benchmarks. One possible arrangement of the database is shown in FIG. 5. The database 32 includes a number of fields 74, 76, 78, 80, 82 and 84 that contain information essentially identifying benchmarks for a successful practice. The entries in the fields could be obtained from a variety of sources or methods: from published statistics, from surveys, from industry associations or trade groups, or from regulatory or licensing bodies. The manner in which the underlying data in the database 32 is obtained is not particularly important. The performance metrics to which a given practitioner's practice will be compared will typically include some or all of the following performance metrics, stored as data in the database in one or more fields:

Revenue from the practice, such as the net fee collected over a period of time, either on a per-patient or per-practice basis, field 74. The net fee collected may exclude selling costs and bad debt.

Capital requirements, field 76. This field may include maintenance and operating costs.

Space requirements, including clinical and office space, field 78;

Number of office visits required by a patient, field 80;

Actual patient chair time in the office, field 82.

Numerous other possible fields 84 are contemplated in the database, including:

assistant and administrative time, including time spent by chair side assistants, lab personnel and assistants, and administration personnel including schedulers, devoted per patient;

practitioner's time devoted per patient;

total time elapsed per patient from initial visit to the final visit;

cost of consumables, which may include both procuring and storing costs;

cost of training and certification, etc., to maintain proficiency for the practitioner and the practitioner's staff,

patient and other demographic factors including pricing elasticity, estimated patient population, etc.;

typical cost of treatment per patient per visit, and overall cost for the complete treatment; and

practitioner's practice workflow.

Referring now to FIGS. 1, 3 and 6, a method will now be described for facilitating care of an orthodontic patient. The method is preferably employed in a unified workstation that maintains (or has access to) a database to enable an orthodontist to compare the effectiveness of the orthodontic treatment administered to a given patient against a clinical benchmark treatment plan that is, in some sense, optimal for the patient. The database consists essentially of very comprehensive collection of individual patient case histories for successful treatment of orthodontic patients. It contains all types of data such as biological and physical information on patients, as well as psychological information concerning patient cooperation in following up the prescribed treatment plan. This approach facilitates evidence based care rather than anecdotal care. Furthermore, in the case where the actual results of the treatment are lagging behind those suggested by the benchmark treatment, the invention enables the orthodontist to diagnose the causes and identify and evaluate corrective actions. Furthermore, the invention enables the orthodontist to develop benchmarks personalized to patients.

One parameter that can be measured to determine adherence to the benchmark is the distance of the tooth movement vs. time; and compared against the value predicted by the benchmark or previous case history. The major benefit is that it aids in achieving the orthodontic treatment results faster and in an effective manner. Another benefit is that the method offers a procedure to gather data related to patient treatment that can be used to develop and enhance benchmark treatment, which when successful is used in enhancing the standards guide to practitioners. In other words evidence based patient care protocol can be developed with such information. Data gathered in this manner are used to develop new, more efficient products. Such data can also be used to explain to the patient the available treatment alternatives, and assist the patient in selecting the most efficient and the best quality care that would satisfy the patient overall needs. In particular embodiments, the invention can be used to predict the treatment response such as the tooth-movement behavior; and to schedule future patient visits. In the current practice, orthodontists largely rely upon trial and error methods and intuition, in a reactive rather than a proactive manner, to make corrective adjustments which may not be the most efficient.

The method of solving the problem relies upon the use of a large knowledge base created by storing the clinical treatment history of individual patients. Such a database categorizes patients according to sex, age, race, risk factors such as physiological, biological, psychosocial, financial, etc. and other parameters deemed important from the view point of the orthodontic treatment.

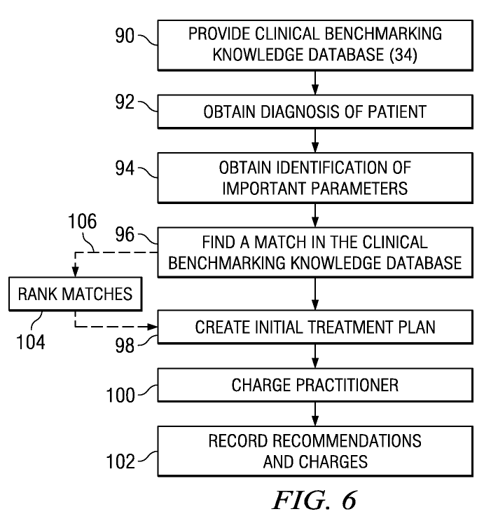

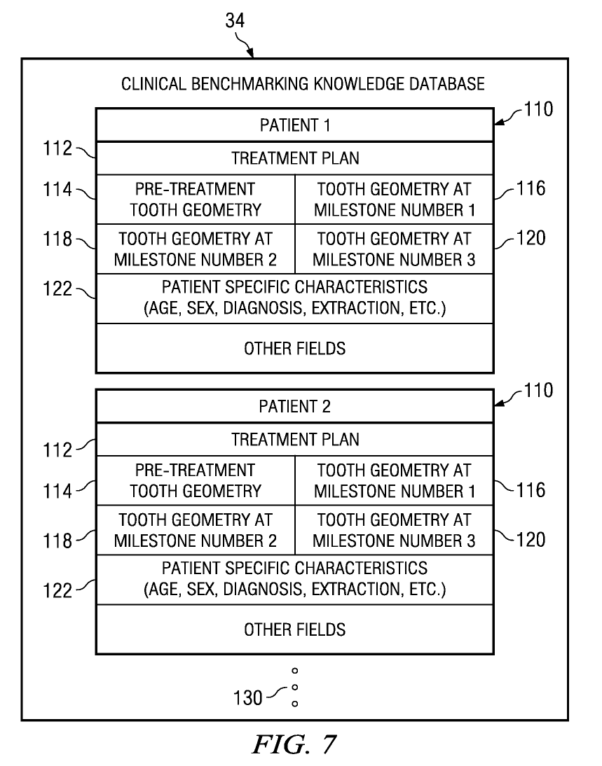

The method of FIG. 6 could be executed by the workstation 24 of FIG. 2 and provided as a service for a fee by a service provider. Alternatively, the method could be performed by a computer at an orthodontic clinic for the practitioner's own use, or it could be provided as a service by an appliance manufacturer. The details as to how and where the method is performed is not especially critical. The method includes a step 90 of providing a clinical benchmarking knowledge database 34 comprising clinical treatment history of individual patients. One possible embodiment of the database 34 is shown in more detail in FIG. 7 and will be described subsequently. Basically, this step involves collecting certain patient information for a large number of patients (including diagnosis, treatment plan, results, time to achieve results, initial and final tooth configurations in 3D and other applicable images, amount of tooth movement, extractions, demographical data, etc.) and storing this patient information in a relational database. The database 34 could be obtained in any of a variety of methods, such as from the practitioner's own patient population, from a sharing or even purchasing of patient data among a number of practitioners, from published literature, from manufacturers of appliances, from professional or industry trade groups, or from surveys.

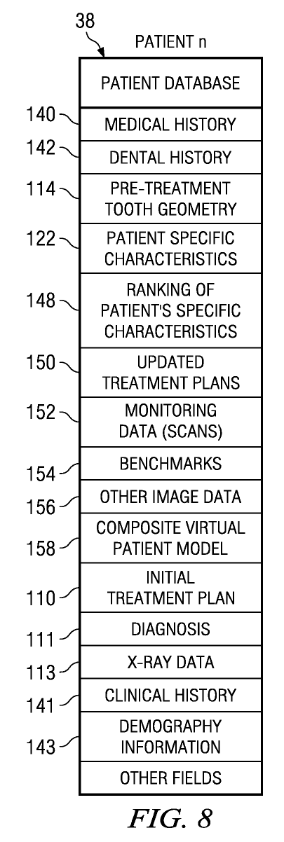

The method continues with a step 92 of obtaining a diagnosis of a given patient. The diagnosis and other patient information may be stored in a patient database (see FIG. 8) or otherwise. It is to be understood that all entries in the patient database are made secure, and preserve privacy in accordance with the applicable state and Federal laws and regulations.

The method further includes the step 94 of obtaining, from the practitioner, an identification of parameters or characteristics deemed important concerning the patient. These parameters or characteristics may include, for example, cost, treatment time, appliance preferences, frequency of visits, type of results, etc.

The method further includes the step 96 of finding a match in the clinical benchmarking knowledge database 34 by comparing the diagnosis from step 92 and the parameters or characteristics from step 94 for the patient with the entries in the clinical benchmarking knowledge database 34. In other words, at step 96 the software looks for a patient record in the database 34 that closely matches the patient's diagnosis and any patient parameters that are provided, such as the 3D configuration of the teeth in the malocclusion and the appliance type(s). This step may be performed by algorithms that perform a comparison of 3D tooth geometries of the present patient and the stored data of 3D tooth geometry prior to treatment from the reference patients in the database to find a “match” for the present patient, and look for similar appliance type. One or more patients with the closest geometry found are chosen as candidate references. Other criteria are then applied to the candidate references, for example length of time taken to realize the desired repositioning of the teeth, for selecting a preferred reference as a match.

Alternately, from step 96 and through link 106, the method continues at step 104 where the matches are ranked.

The method further includes the step 98 of devising an initial treatment plan for the orthodontic patient with the aid of the match from the clinical benchmarking knowledge database. The initial treatment plan may consist of tooth movement steps, appliance designs, stages of treatment, any extractions, or some combination of these features to treat the patient. The initial treatment plan may use as a guidepost the treatment plan of the reference patient in the database as a starting point, with modifications and departures from the treatment plan taken to account for individual tooth anatomy of the patient now under treatment. The treatment plan may be created interactively using interactive treatment planning software described above.

The method further includes the step 100 of charging the practitioner for the service of having access the patient database and providing the initial treatment plan 98. Thus, a business model can arise out of the furnishing of services including the software that obtains the patient information, compares it to a database of clinical benchmarks for patients and providing a treatment plan. The charges assessed could be developed or negotiated in any suitable manner, such as per-patient fee; an annual fee based on the expected or actual number of patients per year, etc. In one possible embodiment, a supplier of orthodontic apparatus could provide the services described in FIG. 6 and the fee could be incorporated into their charge for appliances. The fee charged could be incorporated into other software or hardware (e.g., scanners or computer systems) that are provided to the practitioner. Alternatively, the fee could be tied to the demand volume, or there may be other ways to structure the fees.

It should be noted that step 100 is optional. The method shown in FIG. 6 could be performed entirely by the practitioner for his own practice.

The method further includes the step 102 of recording the recommendations (the initial treatment plan), any changes to the treatment plan made by the practitioner, the reference patient information from the database 34, and any charges, in memory in the computer 24. This data could be stored as a fields in the patient database of FIG. 8, as a new record in the clinical benchmarking database of FIG. 7, or otherwise.

FIG. 7 is a schematic diagram of one possible example of a clinical benchmarking knowledge database 34. The database consists of a plurality or patient records 110. Records for two patients, patient 1 and patient 2, are shown for example. The patient records include a number of fields. These include a field 112 containing data as to the patient treatment plan (nature of appliance, appliance prescription, tooth movement steps, final tooth position, intermediate milestones, etc.). Field 114 contains 3D data of tooth position in the malocclusion, prior to initiation of treatment. The information for field 114 could be obtained from scanners in known fashion. Field 116 contains 3D tooth data for the teeth at a first intermediate milestone, after some treatment time has elapsed. The data for field 116 could be obtained from an in-vivo intra-oral scan, such as provided by the OraMetrix in-vivo scanner. Fields 118 and 120 contain 3D tooth data for tooth positions at second and third milestones, if present. Field 118 could be the final tooth position and field 120 could be empty in the situation where data for only one intermediate tooth position exists.

The patient records also contain a field 122 containing patient specific characteristics, such as age, sex, race, diagnosis, prior tooth extraction, patient preferences regarding cost, appliance type, treatment time, insurance coverage, credit history, financial history, risk factors, etc.

As will be appreciated from FIG. 7, the database 34 will preferably contain similar patient records for hundreds or even thousands of patients, as indicated by the ellipsis 130.

An alternative embodiment of the invention provides a unified workstation system for aiding in facilitating care of an orthodontic patient. The workstation may be for example the workstation 24 of FIG. 1, which a general-purpose computer system having a processor, memory and a user interface, as explained previously. The memory stores a clinical benchmarking knowledge database 34 (see FIG. 7) which comprises clinical treatment history of individual reference patients. The clinical treatment history comprises, for each reference patient, at least (1) a treatment plan, see field 110; (2) three-dimensional data of (a) pre-treatment teeth geometry, field 114, and (b) repositioned teeth at each milestone of the treatment plan, field 116 and (3) a record of patient-specific characteristics, field 122.

The memory in the workstation further stores a patient database for the current patient. A patient database 38 is shown in FIG. 1 and shown in more detail in FIG. 8. The patient database 38 includes a number of fields, many of which are optional. Preferably, the database includes three-dimensional digital information of the current patient's pre-treatment teeth geometry (field 114 of FIG. 8) and a record (field 122) containing patient-specific characteristics for the patient. The field 114 could be for example scan data from an in-vivo scan of the malocclusion or a laser scan data from a scan of a model of an impression of the malocclusion. The field 122 includes patient credit history, financial history, insurance coverage etc.

Optional fields included in the patient database include a medical history field 140, a dental history field 142, a field 148 indicating a ranking of patient-specific characteristics in order of patient preference, such as cost, treatment time, appliance type, frequency of visits, etc. Other fields include a field 110 storing the patient's initial treatment plan, a field 150 containing updated treatment plans, a field 152 containing 3D scans, 3D teeth geometry, tooth movement and disposition from monitoring scans obtained during the course of treatment, a field 154 containing benchmarks for treatment progress, a field 156 containing other image data, such as X-ray, photographs, MRI scans, CT scans, etc. In one possible embodiment, all of the image data including photographs of patients face could be combined into a composite three-dimensional virtual model and stored in a field 158. A method of creating a complete three-dimensional virtual patient from a plurality of images from different imaging devices is described in U.S. Pat. No. 6,512,994, and the patent application filed May 2, 2003 of Rohit Sachdeva, Ser. No. 10/429,123, pending, entitled UNIFIED WORKSTATION FOR VIRTUAL CRANIOFACIAL DIAGNOSIS, TREATMENT PLANNING AND THERAPEUTICS, the contents of both of which are incorporated by reference herein.

The workstation 24 also includes a set of software instructions operating on the patient database 38 of FIG. 8 and the clinical benchmarking knowledge database 34 of FIG. 7 in order to identifying none, one, or more matches from the reference clinical treatment histories in the database 34. The matches, if any, are obtained by comparing the patient's three-dimensional teeth geometry in the malocclusion with the three-dimensional teeth geometry of reference patients in the clinical benchmarking knowledge database to see if they are approximately the same. This could be done for example by calculating a best fit malocclusion occlusal plane for the current patient and for all the records in the clinical benchmark knowledge database, the deviation from selected teeth or all the teeth from the occlusal plane in X, Y and Z directions and in rotational directions, and looking for reference case histories in which a comparison between the current patient and the reference case histories results in a “match”. Other techniques could be used as well.

It may be the case that multiple matching case histories are found, particularly if the patient database is large and has a diverse set of cases. Some ranking of the cases from the case history could be performed. For example, the workstation may include software instructions that arrange the identified matches from the reference clinical treatment histories in a sequential order by (1) comparing the patient's patient-specific characteristics (field 122, FIG. 8) with the patient-specific characteristics (field 122, FIG. 7) of the identified matches and (2) applying value judgment criteria specified by the practitioner. For example, the practitioner may have determined from consultations with the patient that the patient values aesthetic considerations during the course of treatment highly and prefers lingual appliances and/or transparent removable shells above brackets and archwires as a treatment regime, hence the results from the comparison with the clinical benchmarking database will list the lingual appliance cases first, the transparent removable shells second, and then list the bracket cases third. As another example, the patient may want the least cost approach, in which the cases using off-the shelf labial brackets and conventional archwires are listed first.

In one possible embodiment, after treatment commences the patient is periodically imaged or scanned during the course of treatment to monitor progress. The patient database 38 is updated with a set of 2D or 3D images of the patient's treatment response when a milestone in the treatment of the patient is completed. A number of milestones could be set for a given patient, and these scans could be obtained at each milestone. The resulting 3D data from a scan of the patient at each milestone is stored in the patient database, such as in field 152.

In another possible embodiment, the workstation includes a set of software instructions for evaluating the patient's progress in response to the treatment by measuring the distance of movement of the patient's tooth or teeth versus elapsed treatment time (alternatively, quality of tooth movement versus quantity of tooth movement), and comparing the results against the data for the same elapsed time period for a selected clinical benchmark treatment. For example, the software would take the position of a given tooth, compare its position in three-dimensional space at the first milestone with the position of the tooth at the initiation of treatment, and determine how far the tooth has moved. Here, treatment response could be measured in terms of total displacement of the center of the tooth, and rotation movement of the tooth. Calculation of rotation of the tooth could be achieved by constructing a vector from the center of the tooth through the center of crown, and comparing the orientation of the vector at the initial situation with the vector orientation at the milestone to determine rotation and tilting of the tooth. Then, given the total movement (including rotation) and the time elapsed from initiation of treatment to the first milestone, tooth movement per day can be quantified.

This workstation could also include instructions in software that would take this objective measure of tooth movement and compared it with the tooth movement per day in the reference case history to gain some assessment of how well the treatment of the patient is progressing. For example, if the patient's tooth movement is less than 50% of that of the reference patient, progress may be deemed unsatisfactory. Consequently, the workstation may assist in the user performing a root cause analysis to determine the source of the undesirable tooth movement. Various types of root cause analysis are contemplate, both automated and human, are described below. Thus, whenever the patient's progress in response to the treatment is found to be unsatisfactory, the software assists a user in performing a root cause analysis for the problem and for identifying one or more appropriate corrective actions.

As another embodiment, the workstation may also include a software tool for predicting the tooth-movement behavior of the patient under the treatment. For example, given the patient's current tooth positions and the choice of appliance, based on the reference case history it may be predicted that the patient's tooth movement will match that of the reference patient. This prediction of tooth movement can be integrated with another software tool that assists in scheduling said patient's future visits to the practitioner, based on the predicting of tooth-movement behavior. For example, the tooth movement prediction software may predict that the patient will be in condition for placement of finishing wire in 7 weeks, based on the current tooth positions and the reference case history. This information is passed to a scheduling software program which then (1) schedules the patient to come in for a finishing wire in 7 weeks time, and (2) optionally issues any appropriate reminders.

As another alternative, a software tool is provided in the workstation for developing benchmarks personalized to the patient. For example, the patient may have a benchmark for filling in a gap between teeth due to an extraction that is closed in a first stage of treatment, after which the remaining teeth are moved slightly to finish positions. This first benchmark, closing the gap, may be identified in the patient database 38 (in field 154) and the benchmark quantified in terms of tooth position, in three dimensions. This tooth position could be simulated by interactive orthodontic treatment planning using virtual tooth models.

As another alternative embodiment, the workstation may include a software tool that gathers data related to the patient's treatment, such as for example, the benchmarks, initial tooth geometry, final tooth positions, patient characteristics, etc., and transfers this information and incorporates the information into the clinical benchmarking knowledge database 34 of FIG. 7. For example, a new patient record could be created based on the patient database 38, after treatment has concluded. The clinical knowledge database 34 could be updated by simply opening a new record for the patient and using the data in the fields of the patient database 38 to fill in the fields in the new record in the clinical knowledge database.

As yet another alternative, an artificial intelligence tool could be used for facilitating planning a selection of the treatment for the patient.

In yet another alternative, the knowledge base service is a smart service wherein a practitioner selects one or more variables the practitioner would like to track. When the selected variables in actuality approach or cross the desired standards based thresholds, the system would facilitate issuance of warnings, and would identify appropriate corrective-action options, and/or provide links to other information or knowledge bases which may further offer suggested corrective actions. Another feature of this invention is demand aggregation by one or more practitioners or groups of patients for more cost effective purchasing of treatment appliances, supplies, and services. The workstation facilitates archival services as well as knowledge based smart services.

Referring back to FIGS. 1 and 3, the communication from the practitioner with the clinical benchmarking knowledge database may take place over the Internet. Basically, the practitioner would send a file comprising the patient database 38 over the Internet to the service provider, which would then perform the steps described herein to determine treatment plans, establish a match from a record in the clinical knowledge database, etc. After these processes are completed, the service provider would then send the patient database 38 back to the practitioner over the Internet. The patient database 38 could be augmented with one or more recommendations for patient treatment, evaluation of progress, the root cause analysis evaluation in the event treatment is not progressing as well as expected, etc.

From the above discussion, it will be appreciated that we have described a method for providing a service for facilitating care of a patient, the method comprising the steps of:
a) providing a clinical benchmarking knowledge database 34 comprising clinical treatment history of individual patients,
b) receiving information regarding the diagnosis of a patient and parameters deemed important concerning said patient from a practitioner (such as from transmission of a patient database in FIG. 8 including a diagnosis field 111);
c) finding one or more substantial matches from the clinical benchmarking knowledge database by comparing the diagnosis information 111 and the parameters for patient (such as field 122 in FIG. 8) with entries in the clinical benchmarking knowledge database;
d) delivering treatment recommendations for the matches to the practitioner for the patient, such as by sending the patient database 38 back to the practitioner with a proposed treatment plan in field 110; and, optionally
e) charging the practitioner for the use of the clinical benchmarking knowledge database.

The method may optionally further includes the step of keeping a record of the treatment recommendations and the charge assessed to the practitioner.

In one possible embodiment of the method, the parameters or characteristics of importance to the patient, field 122, are associated with a relative importance ranking of the parameters. The method then uses a ranking of the matches into a preferred order list by taking into account the relative importance ranking of the parameters of importance to the patient. Additionally, the method includes the step of delivering treatment recommendations for the matches back to the practitioner taking into account the preferred order list. For example, the treatment recommendations may list the treatments for the patient in order according to their fit with the preferences of the patient.

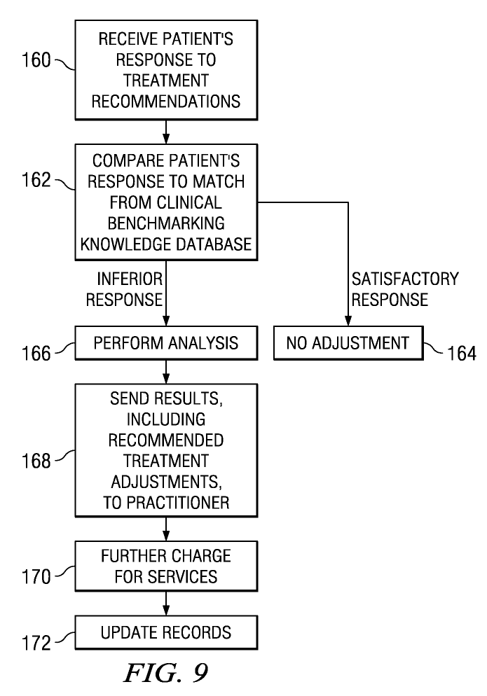

The workstation preferably employs features that can be used during the course of treatment to monitor progress and provide suggestions for corrective action in the event that the treatment is not progressing as anticipated. FIG. 9 is a flow chart showing a method of facilitating patient care using a clinical benchmark knowledge database and a patient's response to an initial treatment plan. The method includes a step 160 of receiving from the practitioner a record of the patient's response to the treatment recommendations, and a reference to the match from the clinical benchmarking knowledge database. This record may simply be the patient database 38, with the field for 3D tooth geometry during the course of treatment filled in with recent scan data of the patient. The method includes a step 162 of comparing the received patient's response with that of the match in the clinical benchmarking knowledge database (e.g., patient n in the database, wherein patient n was the patient that most closely matched the tooth geometry and archform of the patient at the initiation of treatment). When the comparison indicates that the patient's response is satisfactory, no adjustment needs to be made to the treatment plan, as indicated at step 164. Conversely, if the comparison indicates that the response is substantially inferior with that of the match, the method continues by performing an analysis as indicated at step 166. The analysis may reveal that the problem lies in the patient's poor compliance or non-compliance of the prescribed treatment plan. Or, the analysis may ascertain that the problem lies in improper appliance or adverse biological response. Step 166 could be done automatically in software or be done by a human using clinical judgment based on the information in the patient database, or using some combination of automation via software and exercise of human judgment and analysis, such as by display of certain information concerning the treatment, such as tooth position and appliance design and evaluating that information. After step 166 is completed, the method continues with step 168 of sending the results of the analysis, including recommended treatment adjustments, if any, to the practitioner.

As the method of FIG. 9 may be carried out as a business model by a service provider, the method may include a step 170 of further charging the practitioner for the services rendered, which may be for the comparing in step 162, the analysis in step 166, and/or the recommended treatment adjustments in step 168. Finally, the records are updated at step 172.

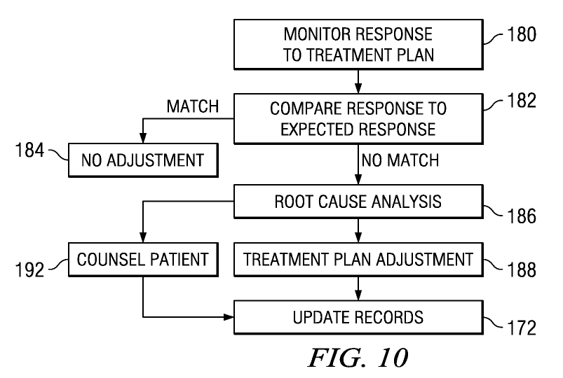

FIG. 10 is a flow chart showing an alternative method of facilitating patient care using a clinical benchmark knowledge database and a patient's response to an initial treatment plan. The method includes a step 180 of monitoring the patient's response to the initial treatment plan; and a step 182 of comparing the monitored or actual response with the response expected from the treatment. A number of parameters are compared at step 182; some parameters may be objectively quantifiable, whereas others may be more judgment oriented. For example, in the case of an orthodontic treatment, tooth displacement as a function of time may be measured objectively in terms of mesial movement, buccal movement, occlusal movement, facial torque, mesial angulation, mesial rotation, etc, per given time period (e.g., month). On the other hand, comparison of esthetic looks would involve subjective judgments based on a visual evaluation. Step 182 may also involve statistical analysis. For example, if the actual value of a certain parameter falls within say one (1) standard deviation of the expected or predicted value, it might be considered an acceptable response; otherwise it might be classified as an unacceptable response. Step 182 may further involve assigning weights to different parameters; and then coming out with one composite weight to see if there is an acceptable match between the monitored response and the expected response.

If there is a match between the monitored response and the expected response, no adjustments are made to the treatment plan 184. However, when the monitored response does not substantially match the expected response, the method continues with step 186 of performing a root cause analysis for inadequate response. There are two possible outcomes from the root cause analysis. One is that there is a need for treatment adjustment, based upon results of the analysis pertaining to the initial diagnosis and the appliance utilized and the underlying premise. This phase of the root cause analysis involves examining the patient's biological response which may have been adverse, anatomical factors and associated constraints and characteristics, interference, ankylosis, bone density, lip pressure, etc. These factors are assigned weights to arrive at an aggregate weight; and probabilistic analysis is then applied to ascertain the future course of the treatment that is most likely to succeed. At the conclusion of this phase of the root cause analysis, step 188 is performed of adjusting the initial treatment plan and improving the predictions for response to the future treatment. The patient records (in the patient database 38) are updated to reflect the adjustment to the treatment plan as shown in step 172. Alternatively, the root cause analysis may indicate a lack of substantial adherence or non-compliance from the patient to the initial treatment plan. Then, step 192 of counseling the patient is performed, and the patient records are updated in step 172.

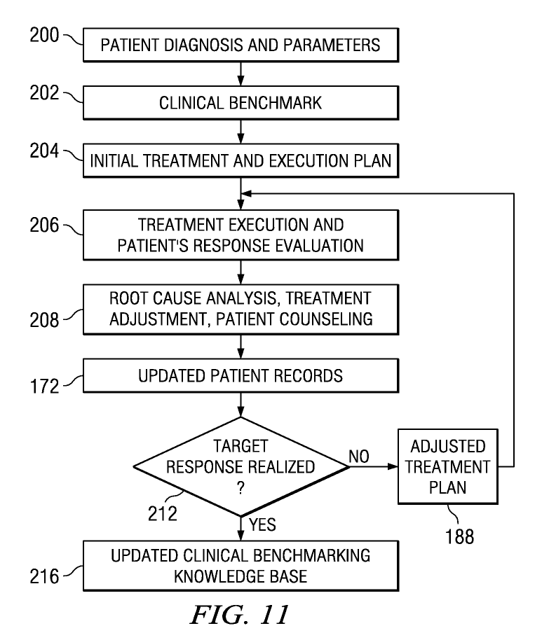

FIG. 11 shows another alternative embodiment of the method for facilitating patient care. The method begins with step 200 of obtaining a patient diagnosis and parameters for care from the patient and entering this information into a patient database. At step 202, this information is compared to the clinical benchmark database to determine whether a match exists. An initial patient treatment and execution plan 204 is obtained, possible deriving from the treatment plan from a match in the clinical benchmark knowledge database. At step 206, the treatment is conducted and during the course of treatment there is an evaluation of the patient. This may include obtaining one or more scans of the patient during the course of treatment and comparing this interim results with the reference in the clinical benchmark database. At step 208, there is a root cause analysis, treatment adjustment and patient counseling in the event of patient non-compliance. The patient records are updated in step 172. At step 212, after some lapse of time, a new evaluation of the patient is made, such as by obtaining one or more new scans of the patient, and a question is asked of whether the targeted response is realized. If not, the treatment plan is adjusted at step 188 and the process reverts back to the execution of the revised treatment plan at step 206 and the process loops as indicated. If, at step 212, the targeted response is achieved, the clinical knowledge database is updated with the new record at step 216—the patient that has been treated. The new entry in the database is thus available for future uses of the clinical benchmark knowledge database. It is to be understood that all entries in the database are made secure; and the privacy and confidentiality is maintained in accordance with the applicable state and Federal laws and regulations and other requirements. The security and privacy is assured through the commercially available technology such as the use of passwords, encryption, etc.

In yet another alternative embodiment, we have conceived of a unified workstation system for facilitating care of an orthodontic patient. The workstation includes a general purpose computer system 24 having a processor, memory and a user interface; and a database 38 containing information for facilitating care of a patient stored in the memory and accessible through the user interface. The information in the database 38 includes diagnosis information (field 111, FIG. 8) comprising (a) clinical examination records in the form of at least one of 2D images, 3D data, CAT scan, MRI, physical model, photographs, digital data from direct scanning of the patient or from scanning of the patient's mold, ultra-sonic images, X-rays, etc; (b) medical health history, including biological, physiological, and physical information as well as psychological information concerning patient cooperation in following prescribed treatment plan, (field 140); (c) dental health history (field 142); (d) radio graphic examination records (field 113),); and preferably (e) clinical history including growth (field 141); and patient demography information (field 143).

The workstation preferably also includes therapeutics information comprising treatment and delivery plans information, which may take a variety of forms including interactive treatment planning software.

The workstation also preferably includes care enterprise information comprising care monitoring and care management information, including information on laboratories, manufacturers, and suppliers for orthodontic treatment apparatus; information on the practitioner and the practitioner's assistants; and insurance coverage information for the patient. This care enterprise information may include links to the websites of the appliance manufacturers, their product catalogs and price sheets, etc.

The workstation also preferably includes records stored in memory of communications between the practitioner and patient (memoranda, letter, email, notes regarding patient visits, etc,) communications between the practitioner and one or more other practitioners, and communications between the practitioner and one or more laboratories, appliance manufacturers, and suppliers.

The workstation also includes a set of software tools enabling said practitioner to access the database 38 and use said database to facilitate the delivery and management of the care of the patient, such as by using the database 38 and the interactive treatment planning software to design a treatment plan and monitor progress of treatment.

The information and the software tools may include instructions aiding the practitioner in making a selection of a treatment plan that satisfies the patient's objectives including cost, duration, and esthetics.

In a preferred embodiment, the software tools comprise instructions designed to aid the practitioner in (a) monitoring and tracking the patient's progress in response to a treatment plan, and (b) in making adjustments to the treatment plan. The workstation may also include the clinical knowledge database in one possible embodiment of the invention, in which case the monitoring and adjustment of the treatment may be in reference to a benchmark case history from the clinical benchmark knowledge database.

As noted above, the instructions in the software may predict the course of treatment based on the clinical reference and use that prediction to assist in scheduling patient visits and sending out reminders for the visits to the patient.

In one possible embodiment, the software tools facilitate orthodontic treatment in which the treatment comprises using the same type of orthodontic appliances at different stages of treatment. Alternatively, the software tools may facilitate orthodontic treatment in which the treatment comprises using different types of orthodontic appliances at different stages of said treatment. For example, the patient may use aligning shells during an initial stage of treatment and finish the treatment with brackets and wires.

Just one practitioner may use the patient database and/or the clinical knowledge database, or, alternatively, the databases may be shared by more than orthodontic practices. In one application, the unified workstation is placed on an enterprise's intranet; while in another it is accessed over the Internet.

In other embodiments the clinical knowledge database could be maintained by a service provider and accessed by means of a subscription of the service provider.

In a preferred embodiment, the workstation provides links to the manufacturers and suppliers of orthodontic equipment and devices. The unified workstation may also facilitate supply chain management between the practitioner and the suppliers, such as by implementing commercially available supply chain management software. The information comprising the patient's therapeutic plan is exchanged with software tools of the suppliers in order to manage the supply of orthodontic devices to the practitioner.

Alternatively, the unified workstation further facilitates bidding services wherein a plurality of suppliers of orthodontic treatment apparatus submit bids to secure the practitioner's business pertaining to the patient's treatment plan. The bidding services may also be extended to the practitioners and to the patients.

As another possible embodiment of the invention, a product benchmarking service may be provided by the workstation, in which practitioners query the workstation for in formation, comparison data, reviews and other types of information regarding dental, orthodontic, prosthodontic and other types of products. In this embodiment, the workstation includes a database of this type of product information and provides and interface such as a query screen or prompts that allow the user to either directly or remotely access the product database.

In yet another embodiment of the invention, the orthodontic treatment prescribed to a patient is a hybrid treatment requiring different types of appliances, such as fixed appliances comprising brackets and arch wires from, for example, Ormco Corporation or OraMetrix, Inc. and removable appliances from, for example, Align Technology, Inc. at different periods of time during the course of the treatment. In a variant embodiment of the invention, the hybrid treatment comprises using different types of appliances during the same as well as different periods of time as appropriate to impart the most optimal treatment to the patient considering patient needs.

Although not specifically shown as a step in any of the figures for the sake of simplicity, it is to be understood that in all of the embodiments of the invention discussed herein, the unified workstation is designed such that all communications, transactions, database entries and access to patient health care information are secured for preserving confidentiality and privacy in accordance with the applicable state, federal, and other regulations and requirements. Security and privacy are achieved through the latest technology commercially available such as the use of passwords, encryption, etc.

While presently preferred embodiments have been described with particularity, departure from the details of the presently preferred embodiments may occur yet fall within the scope of the invention. This true scope is to be determined by reference to the claims.

1-5. (canceled)

6. A method for facilitating care of a patient, the method comprising the steps of:
providing a clinical benchmarking knowledge database comprising clinical treatment history of individual patients;
obtaining a diagnosis of a patient;
obtaining an identification of parameters deemed important concerning said patient;
finding a match in said clinical benchmarking knowledge database by comparing said diagnosis and said parameters for said patient with entries in said clinical benchmarking knowledge database; and
creating an initial treatment plan for the patient with the aid of the match from said clinical benchmarking knowledge database.

7. The method of claim 6, wherein said clinical benchmarking knowledge database is created by a sharing of information resources from multiple sources of information.

8. The method of claim 6, further comprising the steps of:
monitoring said patient's response to said initial treatment plan;
comparing said monitored response with an expected response expected from said treatment;
when said monitored response does not substantially match said expected response, performing a root cause analysis;
when said root cause analysis indicates need for treatment adjustment, adjusting said initial treatment plan;
when said root cause analysis indicates lack of substantial adherence from said patient to said initial treatment plan, counseling said patient.

9. The method of claim 6, further comprising:
updating said clinical benchmarking knowledge database with said patient's records.

10. The method of claim 6, wherein said patient comprises an orthodontic patient and wherein the initial treatment plan comprises a hybrid treatment plan in which a plurality of different types of orthodontic devices (fixed or removeable) are used to treat the patient.

11. The method of claim 10, wherein a first type of orthodontic devices are used during a first portion of the hybrid treatment plan, and a second type of orthodontic devices are used to treat the patient during a second portion of the patient treatment plan.

12. The method of claim 8, wherein the patient is an orthodontic patient and wherein the adjustment of the treatment plan comprises a new path of tooth movement.

13. The method of claim 8, wherein the patient is an orthodontic patient and wherein the adjustment of the treatment plan comprises a change in an appliance type.

14. The method of claim 8, wherein the root cause analysis identifies risks associated with treatment of the patient and identifies an optimum corrective approach in view of the identified risks.

15. A method of facilitating patient care, comprising the steps of:
furnishing information regarding ongoing treatment of a patient to a workstation, said workstation having access to a clinical benchmarking knowledge database comprising clinical treatment histories and characteristics of a plurality of patients;
identifying in the clinical benchmarking database a reference patient and associated treatment plan that matches the patient;
comparing the progress of treatment of the patient with the progress of the reference patient at a comparable elapsed time in treatment, and
providing the results of said comparison to the practitioner.

16. The method of claim 15, wherein, where the results of the comparison indicate a substantial match in progress, adding patient information for said patient to said clinical benchmarking knowledge database.

17. The method of claim 15, wherein, where the results of the comparison do not indicate a substantial match in progress, performing a root cause analysis to identify the source of the lack of progress in the treatment of the patient.

18. The method of claim 17, further comprising the step of providing recommendations to the practitioner for improving the care of the patient.

19. The method of claim 15, wherein, when the results of the comparison indicate a substantial match, performing a prediction of the treatment response of the patient and providing the prediction to the practitioner.

20. The method of claim 19, further comprising the step of using the prediction to further schedule appointments for the patient.

21. A method for providing a service for facilitating care of a patient, the method comprising the steps of:
a) providing a clinical benchmarking knowledge database comprising clinical treatment history of a plurality of individual patients,
b) receiving information regarding the diagnosis of said patient and parameters deemed important concerning said patient from a practitioner;
c) finding one or more substantial matches from said clinical benchmarking knowledge database by comparing said diagnosis information and said parameters for said patient with entries in said clinical benchmarking knowledge database; and
d) delivering treatment recommendations for said matches to said practitioner for said patient.

22. The method of claim 21, further comprising the step:
e) charging the practitioner for the use of the clinical benchmarking knowledge basis to determine said match.

23. The method of step 22, further comprising the step of keeping a record of the treatment recommendations and the charge assessed to the practitioner.

24. The method of claim 21, further comprising the steps of:
receiving said parameters of importance to said patient with a relative importance ranking of said parameters;
ranking said one or more substantial matches into a preferred order list by taking into account said relative importance ranking of said parameters of importance to said patient; and
delivering treatment recommendations for said one or more matches to said practitioner for said patient in a said preferred order list.

25. The method of claim 21, further comprising the steps of:
receiving from said practitioner a record of said patient's response to said treatment recommendations, and a reference to said match from said clinical benchmarking knowledge database;
comparing said received patient's response with that of said match;
when said comparison indicates that said patient's response is substantially inferior with that of said match, performing a root cause analysis;
sending results of said root cause analysis, and recommended treatment adjustments to said practitioner; and
further charging said practitioner for at least one of said comparing, said root cause analysis and said recommended treatment adjustments.

26. The method of claim 21, wherein the patient is an orthodontic patient and wherein the said treatment recommendations comprise a recommendation of a hybrid treatment plan in which a plurality of different types of devices (fixed or removeable) are used for treatment of the patient.

27. The method of claim 21, further comprising the step of comparing the progress of the patient during the course of treatment with the clinical benchmarking database and responsively planning adjustments to the course of treatment of the patient.

28-62. (canceled)
